(19) United States
(12) Patent Application Publication
(10) Pub. No.: US 2025/0307034 A1
(43) Pub. Date: Oct. 2, 2025

(54) ENABLING SYNCHRONIZATION AND SEQUENCING OF MULTIPLE THREADS

(71) Applicant: Lumentum Operations LLC, San Jose, CA (US)

(72) Inventor: David KWONG, Gloucester (CA)

(21) Appl. No.: 18/675,898

(22) Filed: May 28, 2024

Related U.S. Application Data
(60) Provisional application No. 63/571,236, filed on Mar. 28, 2024.

(51) Int. Cl. G06F 9/52; G06F 9/30

(52) U.S. Cl. CPC G06F 9/52; G06F 9/3009

(57) ABSTRACT

In some implementations, a computing device may execute a first thread and may execute a second thread. The computing device may encounter, based on executing the first thread, a first thread coordination operation code (opcode) that is included in the first thread. The computing device may suspend, based on encountering the first thread coordination opcode, execution of the first thread. The computing device may encounter based on executing the second thread, and after suspending execution of the first thread, a second thread coordination opcode that is included in the second thread. The computing device may determine, based on encountering the first thread coordination opcode and encountering the second thread coordination opcode, that a thread coordination event has occurred. The computing device may resume, based on determining that the thread coordination event has occurred, execution of the first thread.

### CROSS-REFERENCE TO RELATED APPLICATION

This Patent Application claims priority to U.S. Patent Application No. 63/571,236, filed on Mar. 28, 2024, and entitled “ENABLING SYNCHRONIZATION AND SEQUENCING OF MULTIPLE THREADS.” The disclosure of the prior Application is considered part of and is incorporated by reference into this Patent Application.

### TECHNICAL FIELD

The present disclosure relates generally to executing multiple threads, and to enabling synchronization and sequencing of multiple threads.

### BACKGROUND

Multi-threading is a programming technique where multiple threads are executed concurrently by a computing device, which enables tasks to run in parallel.

### SUMMARY

In some implementations, a method includes executing, by a computing device, a first thread; executing, by the computing device, a second thread; encountering, by the computing device and based on executing the first thread, a first thread coordination operation code (opcode) that is included in the first thread; suspending, by the computing device and based on encountering the first thread coordination opcode, execution of the first thread; encountering, by the computing device, based on executing the second thread, and after suspending execution of the first thread, a second thread coordination opcode that is included in the second thread; determining, by the computing device and based on encountering the first thread coordination opcode and encountering the second thread coordination opcode, that a thread coordination event has occurred; and resuming, by the computing device and based on determining that the thread coordination event has occurred, execution of the first thread.

In some implementations, a computing device includes one or more memories; and a processor, coupled to the one or more memories, configured to: execute a first thread; encounter, based on executing the first thread, a first thread coordination opcode that is included in the first thread; and suspend, based on encountering the first thread coordination opcode, execution of the first thread.

In some implementations, a non-transitory computer-readable medium storing a set of instructions includes one or more instructions that, when executed by a processor of a computing device, cause the computing device to: encounter, based on executing a first thread, a first thread coordination opcode that is included in the first thread; suspend, based on encountering the first thread coordination opcode, execution of the first thread; encounter, based on executing a second thread, and after suspending execution of the first thread, a second thread coordination opcode that is included in the second thread; and resume, based on encountering the first thread coordination opcode and encountering the second thread coordination opcode, execution of the first thread.

### BRIEF DESCRIPTION OF THE DRAWINGS

FIGS. 1A-1G are diagrams of an example implementation associated with enabling synchronization and sequencing of multiple threads.

FIG. 2 is a diagram of an example environment in which systems and/or methods described herein may be implemented.

FIG. 3 is a diagram of example components of a device associated with enabling synchronization and sequencing of multiple threads.

FIG. 4 is a flowchart of an example process associated with enabling synchronization and sequencing of multiple threads.

### DETAILED DESCRIPTION

The following detailed description of example implementations refers to the accompanying drawings. The same reference numbers in different drawings may identify the same or similar elements.

Multi-threading allows multiple cores of one or more processors (e.g., of a computing device) to execute multiple processes (also called threads) concurrently. A core of a processor executes a sequence of instructions called operation codes (commonly referred to as opcodes) for each thread. An opcode can indicate a specific operation to be performed by the core of the processor, such as an arithmetic calculation, a memory access, or a control flow instruction.

Some opcodes can be used to protect (or lock) a shared resource of multiple threads so that the resource is accessed by a single thread at a time. In this way, by controlling access to the resource, threads can be synchronized (or temporally aligned). However, no opcode allows for a temporal alignment to be established between multiple independent threads (e.g., threads that do not share resources). Further, utilizing external clocks to provide synchronization of parallel execution threads is often subject to jitter and is limited in alignment resolution. External clocks also do not provide any ordering guarantee (e.g., in terms of how blocks of threads are to be executed in a sequence).

This can be problematic for applications that utilize threads to control independent components or devices. For example, a computing device can use a first thread to independently control movement of a mirror of an optical sensing device and a second thread to independently control a sensor of the optical sensing device. Ideally, synchronization of the first thread and the second thread would allow the computing device, by executing the first thread, to cause the mirror to move to a particular position, and then allow the computing device, by executing the second thread, to cause the sensor of the optical sensing device to obtain a sensor measurement (e.g., based on light reflected by the mirror in the particular position). However, existing hardware and software techniques often fail to reliably synchronize the threads exactly in time. Consequently, in some cases, the sensor of the optical sensing device obtains a sensor measurement associated with a time prior to the mirror moving to the particular position and/or a time associated with the mirror moving to another position from the particular position. This impacts a quality of the sensor measurement (e.g., by including measurement information not related to the particular position) and impacts a performance of the optical sensing device (e.g., by reducing a signal-to-noise ratio associated with any resulting sensing determination).

Some implementations described herein include a thread coordination opcode (also referred to as a “timing pylon”). The thread coordination opcode can be included in any thread of multiple threads executed by a computing device (e.g., that are respectively execute by cores of one or more processors of the computing device). Accordingly, the computing device may execute a thread (e.g., one opcode at a time) and may encounter a thread coordination opcode. The computing device then suspends execution of the thread until the computing device determines that a thread coordination event has occurred. A thread coordination event occurs when the computing device, based on executing one or more other threads, encounters other corresponding thread coordination opcodes (e.g., other thread coordination opcodes that have matching identifiers to the thread coordination opcode and/or that have matching coordination matching counts that indicate a total number of thread coordination opcodes encountered by the computing device). Accordingly, based on determining that the thread coordination event has occurred, the computing device resumes execution of the thread and any other threads associated with the other corresponding thread coordination opcodes that were suspended prior to the thread coordination event.

This causes the computing device to execute the thread coordination opcode and the other corresponding thread coordination opcodes in association with an instant of time. In this way, the computing device causes execution of multiple threads (e.g., that include the thread coordination opcode and the other corresponding thread coordination opcodes) to be synchronized. For example, the computing device may execute portions of the threads (e.g., that comprise opcodes sequenced after respective thread coordination opcodes) starting at the instant of time (or nearly at the instant of time). Accordingly, the instant of time may be referred to as an “instant of synchronization” of the threads.

Further, the computing device initiates or resets a timer to commence at the instant in time. Any of the threads can then include a thread delay opcode, which, when encountered by the computing device, causes the computing device to suspend the thread for an amount of time indicated by the thread delay opcode (e.g., with reference to the timer or to execution of other opcodes). This allows execution of blocks of the particular threads to be ordered and executed in a particular sequence (e.g., with respect to execution of opcodes in other threads that are referenced to the same instant of synchronization). This would not be possible without the accurate synchronization of the threads due to the thread coordination opcodes.

Accordingly, in an example where the computing device executes a first thread to independently control movement of a mirror of an optical sensing device, and executes a second thread to independently control a sensor of the optical sensing device, the first thread and the second thread may include thread coordination opcodes to cause the first thread and the second thread to be synchronized in association with an instant of time. The first thread and the second thread may also include respective thread delay opcodes to allow one thread to suspend while the other thread is controlling its corresponding component. This therefore increases a likelihood that the sensor of the optical sensing device obtains a sensor measurement associated with a time when the mirror is at a particular position (and not when the mirror is moving to or from another position). This therefore improves a quality of the sensor measurement and improves a performance of the optical sensing device (e.g., as compared to when thread coordination opcode and thread delay opcodes are not utilized in threads executed by the computing device).

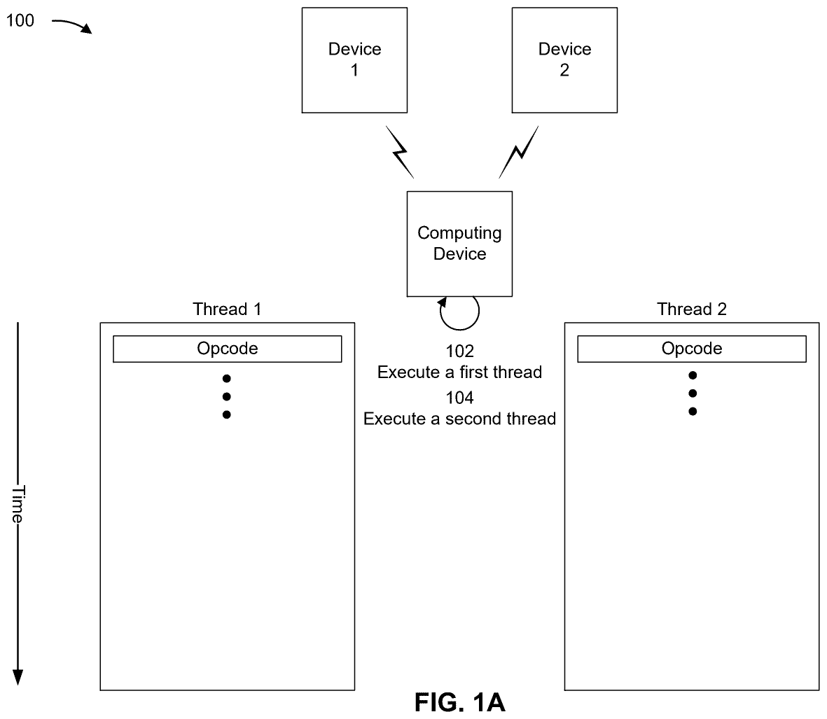

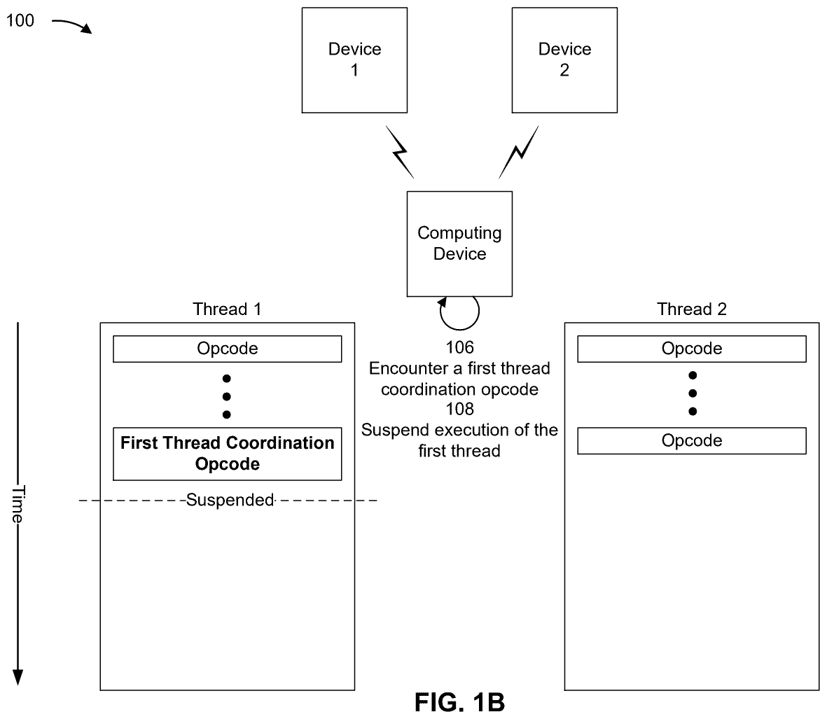

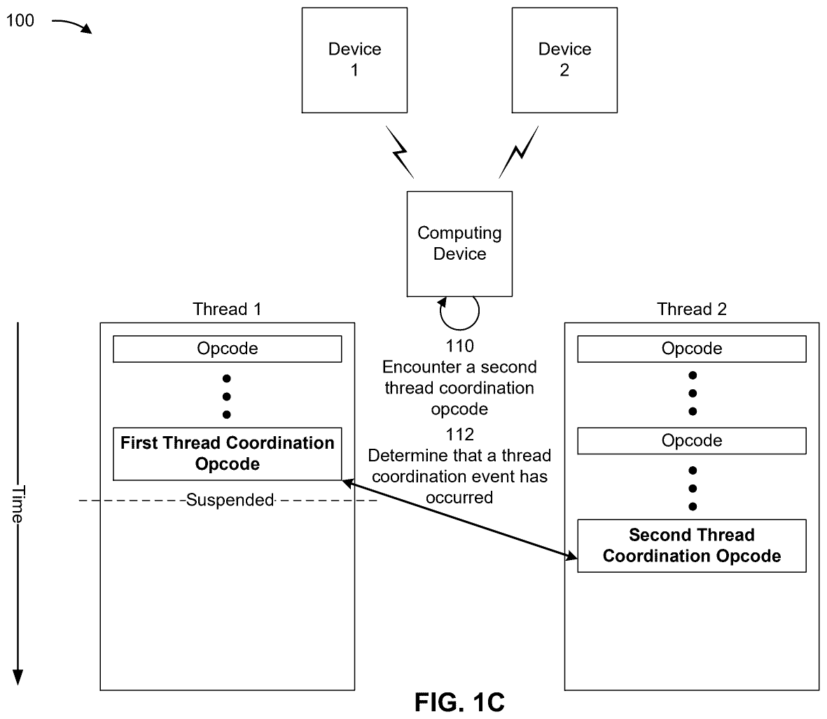

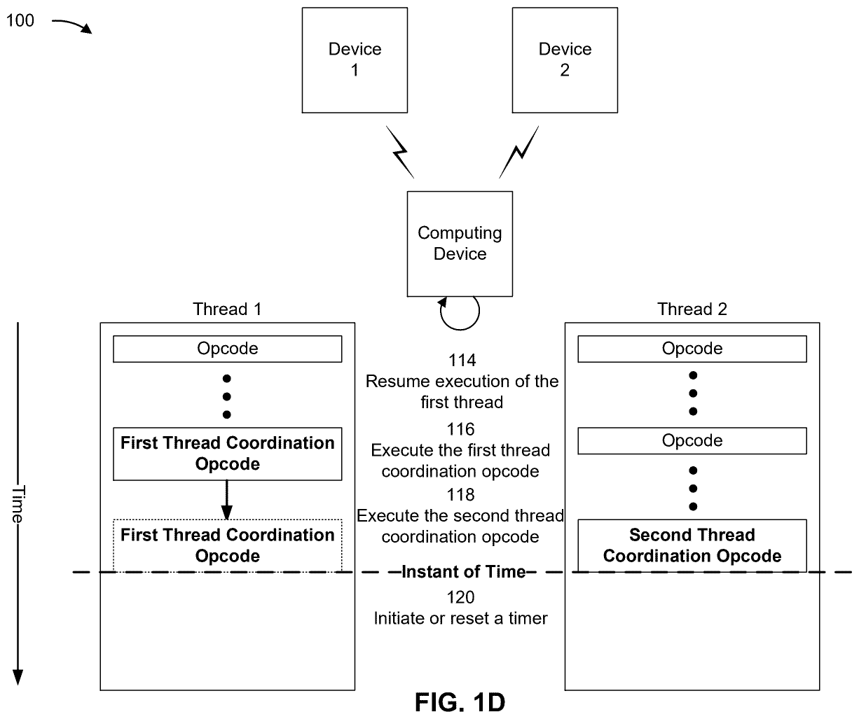

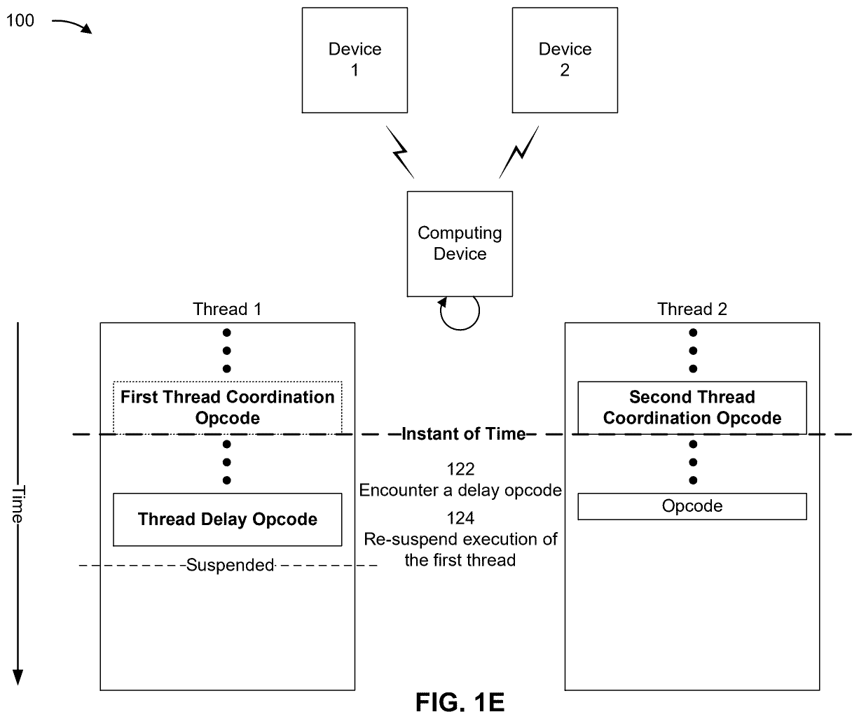

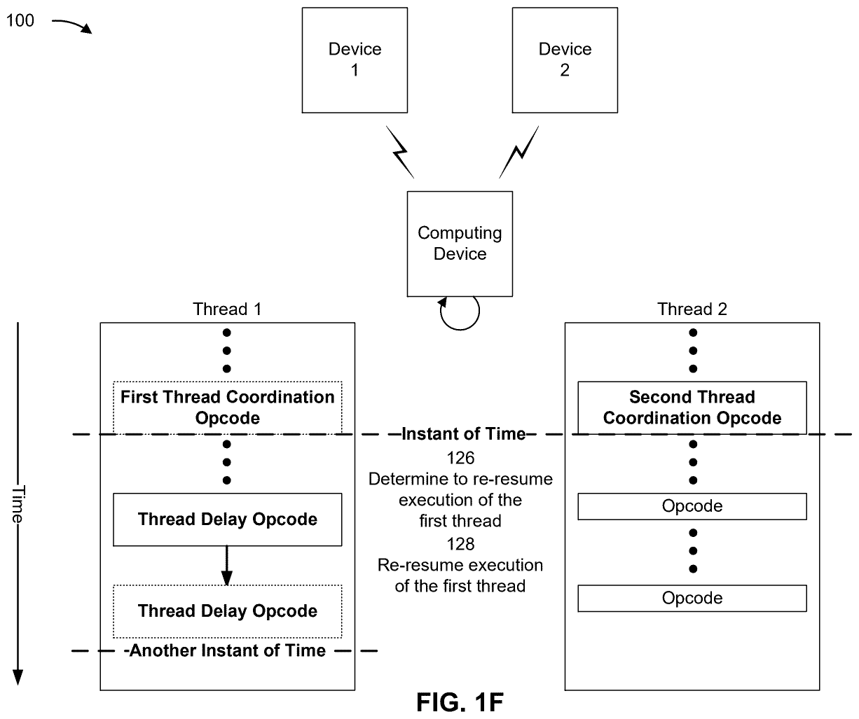

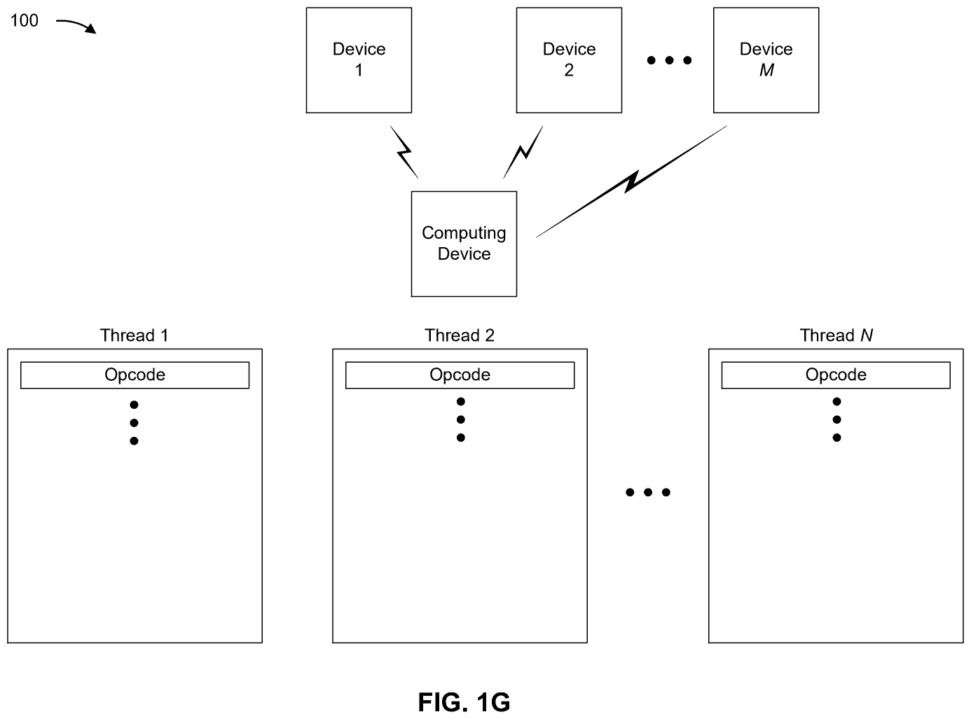

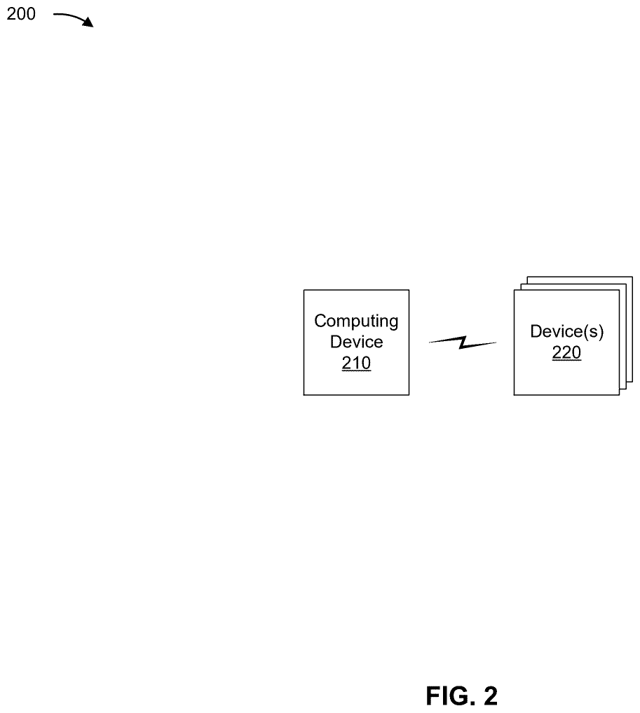

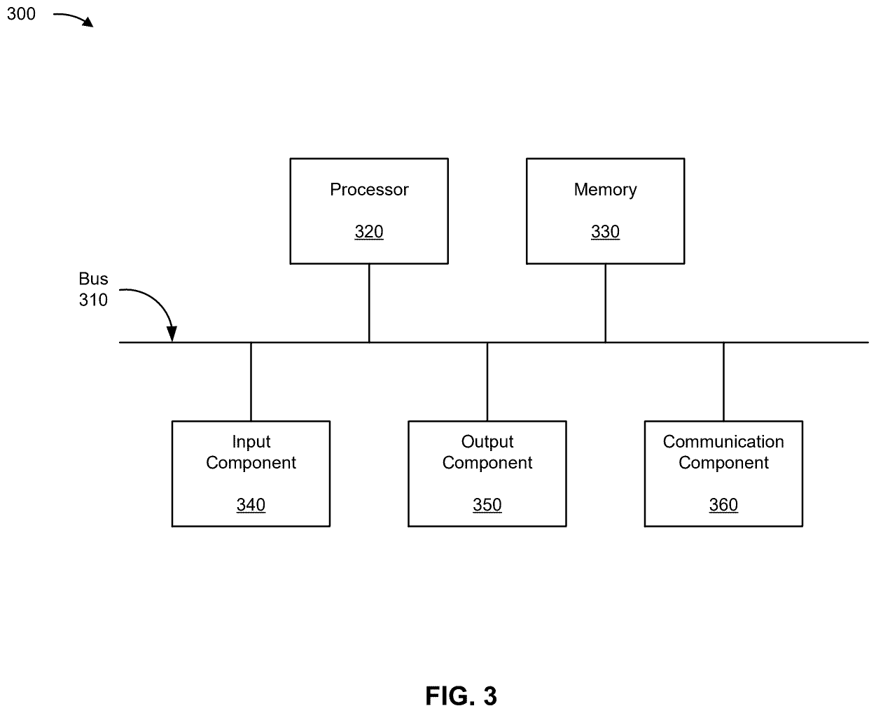

FIGS. 1A-1G are diagrams of an example implementation 100 associated with enabling synchronization and sequencing of multiple threads. As shown in FIGS. 1A-1G, example implementation 100 includes a computing device and/or one or more devices (shown as devices 1 through M, where M≥1). These devices are described in more detail below in connection with FIG. 2 and FIG. 3.

The computing device may be configured to communicate with each device of the one or more devices. For example, the computing device may be configured to communicate with the one or more devices to control each device. In some implementations, the computing device may execute multiple threads (e.g., shown as threads 1 through N, where N>1), such as to control the one or more devices (e.g., where each thread is associated with controlling a device of the one or more devices). The computing device may execute the multiple threads in a same time window (e.g., using a multi-threading processing technique, such as where each thread is executed using a core of a processor, of one or more processors, of the computing device). Accordingly, the computing device may perform one or more of the operations further described herein in relation to FIGS. 1A-1G.

As shown in FIG. 1A, and by reference number 102, the computing device may execute a first thread (shown as Thread 1). This may include, for example, sequentially reading and executing opcodes that are included in the first thread. Additionally, as shown by reference number 104, the computing device may execute a second thread (shown as Thread 2). This may include, for example, sequentially reading and executing opcodes that are included in the second thread.

Notably, while the threads are described herein with an ordinal nomenclature (e.g., first, second, and so on), there is no ordering of the threads by the computing device (e.g., when the computing device executes the threads). Rather the computing device executes the multiple threads concurrently (e.g., during a same time window, such as by using a multi-threading processing technique). Therefore, threads are labeled herein as “first,” “second,” and so on, for clarity's sake and only to distinguish individual threads from one another.

As shown in FIG. 1B, and by reference number 106, the computing device may encounter a first thread coordination opcode (e.g., based on executing the first thread) that is included in the first thread. For example, as part of executing the first thread, the computing device may sequentially read and execute opcodes in the first thread and then, accordingly, may encounter the first thread coordination opcode (e.g., because the first thread coordination opcode is included in a particular position within the first thread). The first thread coordination opcode may indicate that the computing device is to suspend execution of the first thread (e.g., until at least one corresponding thread coordination opcode is encountered by the computing device executing one or more other threads) or to synchronize execution of the first thread (e.g., with one or more threads, execution of which already caused the computing device to encounter at least one corresponding thread coordination opcode). In some implementations, the first thread coordination opcode may include a first identifier (e.g., a first alpha-numeric string) and/or may include a first coordination matching count that indicates a number of thread coordination opcodes (e.g., in other threads) that the first thread coordination opcode is to correspond to (e.g., for there to be a thread coordination event, as further described herein).

Accordingly, as shown by reference number 108, the computing device may suspend execution of the first thread. For example, the computing device may identify the first thread coordination opcode (e.g., based on encountering the first thread coordination opcode) and may therefore suspend execution of the first thread (e.g., because the computing device has not encountered any other corresponding thread coordination opcode and therefore a thread coordination event has not occurred, as further described herein). The computing device may suspend execution of the first thread by ceasing to sequentially read and execute other opcodes that are included in the first thread (and/or by not completing execution of the first thread coordination opcode). That is, the computing device may “pause” its execution of the first thread at the first thread coordination opcode.

As shown in FIG. 1C, and by reference number 110, the computing device may encounter a second thread coordination opcode (e.g., based on executing the second thread) that is included in the second thread. For example, as part of executing the second thread, the computing device may sequentially read and execute opcodes in the second thread and then, accordingly, may encounter the second thread coordination opcode (e.g., because the second thread coordination opcode is included in a particular position within the second thread). As shown in FIG. 1C, the computing device may encounter the second thread coordination opcode after suspending execution of the first thread (e.g., based on encountering the first thread coordination opcode). The second thread coordination opcode may indicate that the computing device is to suspend execution of the second thread (e.g., until at least one corresponding thread coordination opcode is encountered by the computing device executing one or more other threads) or to synchronize execution of the second thread (e.g., with one or more threads, execution of which caused the computing device to already encounter at least one corresponding thread coordination opcode). In some implementations, the second thread coordination opcode may include a second identifier (e.g., a second alpha-numeric string) and/or may include a second coordination matching count that indicates a number of thread coordination opcodes (e.g., in other threads) that the second thread coordination opcode is to correspond to (e.g., for there to be a thread coordination event, as further described herein).

In some implementations, the computing device may suspend execution of the second thread. For example, the computing device may identify the second thread coordination opcode (e.g., based on encountering the second thread coordination opcode) and may therefore suspend execution of the second thread. The computing device may suspend execution of the second thread by ceasing to sequentially read and execute other opcodes that are included in the second thread (and/or by not completing execution of the second thread coordination opcode). That is, the computing device may pause its execution of the second thread at the second thread coordination opcode.

Accordingly, the computing device may determine whether a thread coordination event has occurred. A thread coordination event has occurred when corresponding thread coordination opcodes are encountered in multiple threads. Thread coordination opcodes may correspond to each other when each thread coordination opcode includes an identifier that matches identifiers of other thread coordination opcodes of the multiple threads (e.g., at least portions of the identifiers are the same). Additionally, or alternatively, thread coordination opcodes may correspond to each other when each thread coordination opcode includes a coordination matching count that indicates a same number of thread coordination opcodes of other thread coordination opcodes of the multiple threads (and the number of threads, of the multiple threads that include the thread coordination opcodes, is equal to the number indicated by each coordination matching count). That is, a thread coordination event has occurred when the computing device has encountered multiple thread coordination opcodes (e.g., in an X number of threads), and each thread coordination opcode has a matching identifier and/or each thread coordination opcode indicates that an X number of thread coordination opcodes need to be encountered for a thread coordination event to have occurred.

Accordingly, as shown by reference number 112, the computing device may determine that a thread coordination event has occurred. For example, the computing device may determine that the first thread coordination opcode (e.g., that was encountered based on executing the first thread) corresponds to the second thread coordination opcode (e.g., that was encountered based on executing the second thread) and may thereby determine that the thread coordination event has occurred. The computing device may determine that the first thread coordination opcode corresponds to the second thread coordination opcode based on determining that the first identifier, of the first thread coordination opcode, matches the second identifier of the second thread coordination opcode (e.g., at least portions of the first identifier and the second identifier are the same). Additionally, or alternatively, the computing device may determine that the first thread coordination opcode corresponds to the second thread coordination opcode based on determining that the computing device has encountered two thread coordination opcodes (e.g., in the first thread and the second thread) and that the first coordination matching count, of the first thread coordination opcode, is equal to the second coordination matching count of the second thread coordination opcode (e.g., each coordination matching count indicates two thread coordination opcodes that need to have been encountered by the computing device).

As another example, the computing device may determine that a thread coordination event has occurred (e.g., for any number of threads) by determining that the first thread coordination opcode was encountered (e.g., based on executing the first thread), by determining that the second thread coordination opcode was encountered (e.g., based on executing the second thread), and, optionally, that at least one other thread coordination opcode was encountered (e.g., based on executing the at least one other thread). That is, the computing device may determine that each thread coordination opcode (e.g., of the first thread coordination opcode, the second thread coordination opcode, and, optionally, the at least one other thread coordination opcode) corresponds to each other thread coordination opcode, such as by determining that identifiers of the thread coordination opcodes match and/or that a total number of the thread coordination opcodes is indicated by the coordination matching count of each thread coordination opcode.

As shown in FIG. 1D, and by reference number 114, the computing device may resume execution of the first thread (e.g., based on determining that the thread coordination event has occurred). The computing device may resume execution of the first thread by returning to sequentially reading and executing opcodes that are included in the first thread. That is, the computing device may “restart” its execution of the first thread at or after the first thread coordination opcode.

Accordingly, as shown by reference number 116, the computing device may execute the first thread coordination opcode (e.g., as a result of resuming execution of the first thread). For example, the computing device may execute, or may resume completion of, the first thread coordination opcode as a way to continue executing other opcodes of the first thread (e.g., that are sequenced after the first thread coordination opcode in the first thread). In some implementations, the computing device may execute, or may complete execution of, the first thread coordination opcode in association with an instant of time (e.g., within the time window in which the multiple threads are executed by the computing device).

As shown by reference number 118, the computing device may execute, or may complete execution of, the second thread coordination opcode (e.g., based on determining that the thread coordination event has occurred). For example, the computing device may execute, or may complete execution of, the second thread coordination opcode as a way to continue executing other opcodes of the second thread (e.g., that are sequenced after the second coordination opcode in the second thread). In some implementations, the computing device may execute, or may complete execution of, the second thread coordination opcode in association with the instant of time (e.g., the same instant of time at which the computing device executes the first thread coordination opcode). That is, the computing device may execute, or may complete execution of, the second thread coordination opcode at the same time (e.g., within a tolerance, such as within a time accuracy resolution associated with a processing speed of the computing device).

In this way, the computing device may cause execution of the first thread and the second thread to be synchronized. For example, the computing device may execute a portion of the first thread (e.g., that comprises opcodes sequenced after the first thread coordination opcode) starting at the instant of time and may execute a portion of the second thread (e.g., that comprises opcodes sequenced after the second thread coordination opcode) starting at the instant of time (or nearly at the instant of time). Accordingly, the instant of time may be referred to as an “instant of synchronization” (e.g., of the first thread and the second thread).

As shown by reference number 120, the computing device may initiate or reset a timer (e.g., based on determining that the thread coordination event has occurred). For example, the computing device may cause a commencement time of the timer to be the instant of time (e.g., that is associated with the computing device executing the first thread coordination opcode, based on resuming execution of the first thread; and with the computing device executing the second thread coordination opcode, based on determining that the thread coordination event has occurred). That is, the computing device may cause the timer to commence at the instant of time when the computing device executes the first thread coordination opcode and the second thread coordination opcode. Accordingly, the timer may measure an amount of time that has elapsed since the instant of time (e.g., since the instant of synchronization).

As shown in FIG. 1E, and by reference number 122, the computing device may encounter a thread delay opcode (e.g., based on resuming execution of the first thread) that is included in the first thread. For example, as part of executing the first thread (e.g., after resuming execution of the first thread), the computing device may sequentially read and execute opcodes in the first thread (e.g., that are sequenced after the first thread coordination opcode) and then, accordingly, may encounter the thread delay opcode. The thread delay opcode may indicate that the computing device is to suspend (again) execution of the first thread and that the first thread is to remain suspended until an amount of time has passed. In some implementations, the amount of time may be a cumulative amount of time since executing the first thread coordination opcode (e.g., in association with resuming execution of the first thread). Accordingly, the amount of time, may be, for example, an amount of time since the commencement time of the timer (e.g., since the instant of time). Alternatively, the amount of time may be a relative amount of time since execution of another opcode (e.g., since execution of another thread delay opcode or another type of opcode). Accordingly, the amount of time, may be, for example, an amount of time since another instant of time of the timer (e.g., after the commencement time of the timer).

Accordingly, as shown by reference number 124, the computing device may re-suspend execution of the first thread. For example, the computing device may identify the thread delay opcode (e.g., based on encountering the thread delay opcode) and may therefore re-suspend execution of the first thread. The computing device may re-suspend execution of the first thread by ceasing to sequentially read and execute other opcodes that are included in the first thread (and/or by not completing execution of the thread delay opcode). That is, the computing device may pause its execution of the first thread at the thread delay opcode.

As shown in FIG. 1F, and by reference number 126, the computing device may determine to re-resume execution of the first thread. In some implementations, the computing device may determine that at least the amount of time indicated by the thread delay opcode has passed. For example, when the amount of time is the cumulative amount of time since executing the first thread coordination opcode (e.g., in association with resuming execution of the first thread), the computing device may check the timer and may determine that a difference between a current time and the commencement time of the timer is greater than or equal to the amount of time indicated by the thread delay opcode. As another example, when the amount of time is the relative amount of time since execution of another opcode (e.g., in association with resuming execution of the first thread), the computing device may check the timer and may determine that a difference between a current time and the other instant of time of the timer is greater than or equal to the amount of time indicated by the thread delay opcode. Accordingly, the computing device may determine to re-resume execution of the first thread.

Accordingly, as shown by reference number 128, the computing device may re-resume execution of the first thread (e.g., based on determining to re-resume execution of the first thread, such as based on determining that at least the amount of time indicated by the thread delay opcode has passed). The computing device may re-resume execution of the first thread by returning to sequentially reading and executing opcodes that are included in the first thread. That is, the computing device may restart its execution of the first thread at or after the thread delay opcode.

Accordingly, the computing device may execute the thread delay code (e.g., as a result of re-resuming execution of the first thread). For example, the computing device may execute, or may resume completion of, the thread delay code as a way to continue executing other opcodes of the first thread (e.g., that are sequenced after the thread delay code in the first thread). In some implementations, the computing device may execute, or may resume completion of, the thread delay code in association with another instant of time (e.g., after the instant of time, but within the time window in which the multiple threads are executed by the computing device).

In some implementations, the computing device may encounter another thread delay opcode (e.g., based on re-resuming execution of the first thread) that is included in the first thread, such as in a similar manner as that described herein in relation to FIG. 1E and reference number 122. The other thread delay opcode may indicate that the computing device is to suspend (again) execution of the first thread and that the first thread is to remain suspended until an amount of time has passed. The amount of time may be a cumulative amount of time since executing the first thread coordination opcode (e.g., in association with resuming execution of the first thread) or a relative amount of time since execution of another opcode (e.g., since execution of another thread delay opcode, such as the thread delay opcode shown in FIGS. 1E and 1F, or another type of opcode).

Accordingly, the computing device may again suspend execution of the first thread, such as in a similar manner as that described herein in relation to FIG. 1E and reference number 124. The computing device then may determine to again resume execution of the first thread, such as in a similar manner as that described herein in relation to FIG. 1F and reference number 126. For example, the computing device may determine that at least the amount of time indicated by the other thread delay opcode has passed and may thereby determine to again resume execution of the first thread. Accordingly, the computing device may again resume execution of the first thread and thereby execute the other thread delay code, such as in a similar manner as that described herein in relation to FIG. 1F and reference number 128.

While some operations described herein in relation to FIGS. 1A-1F are performed by the computing device in relation to the first thread, and other operations described herein in relation to FIGS. 1A-1F are performed by the computing device in relation to the second thread, any number of the same or similar operations may be performed by the computing device in relation to either the first thread or the second thread. Further, as shown by FIG. 1G, the computing device may perform any number of the same or similar with respect to any number of threads (e.g., N threads).

In this way, the computing device may use corresponding thread coordination opcodes in the N threads to cause the N threads to be synchronized. That is, the computing device may suspend execution of N−1 of the threads (e.g., after encountering a thread coordination opcode in each thread of the N−1 of the threads) until encountering a thread coordination opcode in the N^{th} thread. The computing device then may determine that a thread coordination event has occurred and may resume the suspended N−1 threads, which causes the computing device to execute the respective thread coordination opcodes of the N threads in association with an instant of time (e.g., in association with an instant of synchronization).

Further, particular threads of the N threads may include thread delay opcodes to suspend the particular threads for respective amounts of time (e.g., relative to a timer that commenced at the instant of time, or relative to execution of other opcodes). This allows execution of blocks of the particular threads to be ordered and executed in a particular sequence.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram of an example environment 200 in which systems and/or methods described herein may be implemented. As shown in FIG. 2, environment 200 may include a computing device 210 and one or more devices 220. Devices of environment 200 may interconnect via wired connections, wireless connections, or a combination of wired and wireless connections.

The computing device 210 may include one or more devices capable of receiving, generating, storing, processing, and/or providing information, as described elsewhere herein. The computing device 210 may include a communication device and/or a computing device. For example, the computing device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The computing device 210 may be configured to execute multiple threads (e.g., using a multi-threading technique) and to enabling synchronization and sequencing of multiple threads, as described herein.

The device 220 may include one or more devices capable of receiving, generating, storing, processing, and/or providing information, as described elsewhere herein. In some implementations, the device 220 may include a communication device and/or a computing device. For example, the device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the device 220 may include a sensor device. For example, the device 220 may include a temperature sensor, a moisture sensor, a humidity sensor, an accelerometer, a gyroscope, a proximity sensor, a light sensor, a noise sensor, a pressure sensor, an ultrasonic sensor, a smoke sensor, a gas sensor (e.g., a carbon monoxide sensor, an oxygen sensor, and/or a carbon dioxide sensor), a chemical sensor, an alcohol sensor, a positioning sensor, a capacitive sensor, a timing device, an infrared sensor, an active sensor (e.g., a sensor that requires an external power signal), a passive sensor (e.g., a sensor that does not require an external power signal), a biological sensor, a radioactive sensor, a magnetic sensor, an electromagnetic sensor, an analog sensor, and/or a digital sensor, among other examples. Accordingly, the device 220 may sense or detect a condition or information and transmit, using a wired or wireless communication interface, an indication of the detected condition or information to other devices in the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with enabling synchronization and sequencing of multiple threads. The device 300 may correspond to the computing device 210 and/or the device 220. In some implementations, the computing device 210 and/or the device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

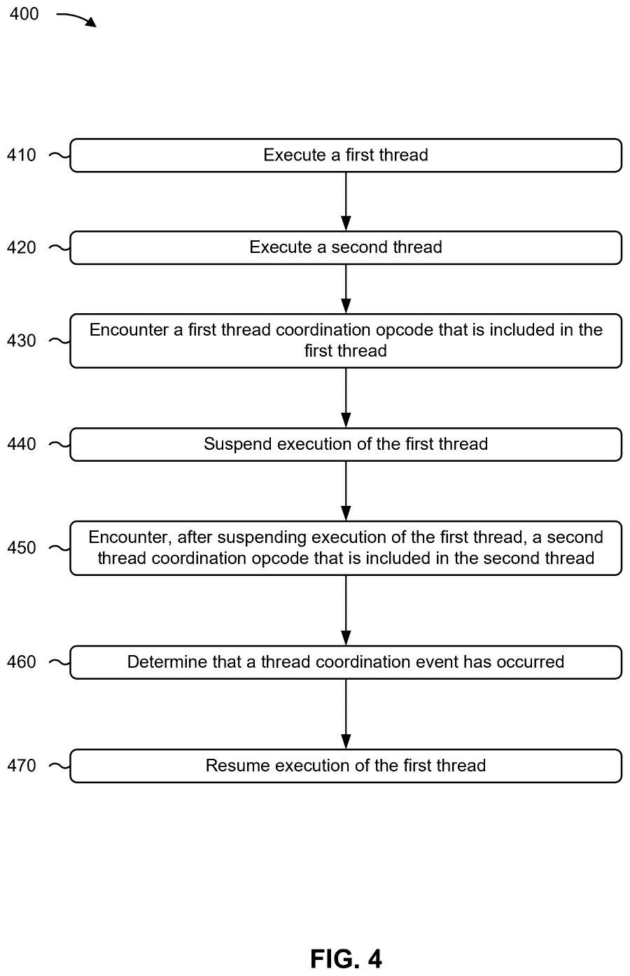

FIG. 4 is a flowchart of an example process 400 associated with enabling synchronization and sequencing of multiple threads. In some implementations, one or more process blocks of FIG. 4 are performed by a computing device (e.g., computing device 210). In some implementations, one or more process blocks of FIG. 4 are performed by another device or a group of devices separate from or including the computing device, such as a device (e.g., device 220). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include executing a first thread (block 410). For example, the computing device may execute a first thread, as described above.

As further shown in FIG. 4, process 400 may include executing a second thread (block 420). For example, the computing device may execute a second thread, as described above.

As further shown in FIG. 4, process 400 may include encountering a first thread coordination opcode that is included in the first thread (block 430). For example, the computing device may encounter, based on executing the first thread, a first thread coordination opcode that is included in the first thread, as described above.

As further shown in FIG. 4, process 400 may include suspending execution of the first thread (block 440). For example, the computing device may suspend, based on encountering the first thread coordination opcode, execution of the first thread, as described above.

As further shown in FIG. 4, process 400 may include encountering, after suspending execution of the first thread, a second thread coordination opcode that is included in the second thread (block 450). For example, the computing device may encounter based on executing the second thread, and after suspending execution of the first thread, a second thread coordination opcode that is included in the second thread, as described above.

As further shown in FIG. 4, process 400 may include determining that a thread coordination event has occurred (block 460). For example, the computing device may determine, based on encountering the first thread coordination opcode and encountering the second thread coordination opcode, that a thread coordination event has occurred, as described above.

As further shown in FIG. 4, process 400 may include resuming execution of the first thread (block 470). For example, the computing device may resume, based on determining that the thread coordination event has occurred, execution of the first thread, as described above.

Process 400 may include additional implementations, such as any single implementation or any combination of implementations described below and/or in connection with one or more other processes described elsewhere herein.

In a first implementation, process 400 includes executing, based on resuming execution of the first thread, the first thread coordination opcode in association with an instant of time; and executing, based on determining that the thread coordination event has occurred, the second thread coordination opcode in association with the instant of time.

In a second implementation, alone or in combination with the first implementation, process 400 includes initiating or resetting, based on determining that the thread coordination event has occurred, a timer, wherein a commencement time of the timer is an instant of time associated with: the computing device executing, based on resuming execution of the first thread, the first thread coordination opcode, and the computing device executing, based on determining that the thread coordination event has occurred, the second thread coordination opcode.

In a third implementation, alone or in combination with one or more of the first and second implementations, process 400 includes encountering, based on resuming execution of the first thread, a thread delay opcode that is included in the first thread; re-suspending, based on encountering the thread delay opcode, execution of the first thread; determining, after re-suspending execution of the first thread, that at least an amount of time indicated by the thread delay opcode has passed since executing the first thread coordination opcode in association with resuming execution of the first thread; and re-resuming, based on determining that at least the amount of time indicated by the thread delay opcode has passed, execution of the first thread.

In a fourth implementation, alone or in combination with one or more of the first through third implementations, process 400 includes encountering, based on resuming execution of the first thread, a first thread delay opcode that is included in the first thread; re-suspending, based on encountering the first thread delay opcode, execution of the first thread; re-resuming execution of the first thread, based on determining that at least an amount of time indicated by the first thread delay opcode has passed since executing the first thread coordination opcode in association with resuming execution of the first thread; encountering, based on re-resuming execution of the first thread, a second thread delay opcode that is included in the first thread; and suspending again, based on encountering the second thread delay opcode, execution of the first thread.

In a fifth implementation, alone or in combination with one or more of the first through fourth implementations, process 400 includes resuming again, after suspending again execution of the first thread, and based on determining that at least an amount of time indicated by the second thread delay opcode has passed since executing the first thread coordination opcode in association with resuming execution of the first thread, execution of the first thread.

In a sixth implementation, alone or in combination with one or more of the first through fifth implementations, process 400 includes resuming again, after suspending again execution of the first thread, and based on determining that at least an amount of time indicated by the second thread delay opcode has passed since executing the first thread delay opcode in association with re-resuming execution of the first thread, execution of the first thread.

In a seventh implementation, alone or in combination with one or more of the first through sixth implementations, the first thread coordination opcode includes a first identifier and the second thread coordination opcode includes a second identifier, and determining that the thread coordination event has occurred comprises determining that the thread coordination event has occurred based on the first identifier matching the second identifier.

In an eighth implementation, alone or in combination with one or more of the first through seventh implementations, determining that the thread coordination event has occurred comprises determining that the first thread coordination opcode was encountered; determining that the second thread coordination opcode was encountered; determining that at least one other thread coordination opcode was encountered based on executing at least one other thread; and determining that the thread coordination event has occurred based on determining that the first thread coordination opcode was encountered, determining that the second thread coordination opcode was encountered, and determining that at least one other thread coordination opcode was encountered based on executing at least one other thread.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a processor or one or processors) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
executing, by a computing device, a first thread;
executing, by the computing device, a second thread;
encountering, by the computing device and based on executing the first thread, a first thread coordination operation code (opcode) that is included in the first thread;
suspending, by the computing device and based on encountering the first thread coordination opcode, execution of the first thread;
encountering, by the computing device, based on executing the second thread, and after suspending execution of the first thread, a second thread coordination opcode that is included in the second thread;
determining, by the computing device and based on encountering the first thread coordination opcode and encountering the second thread coordination opcode, that a thread coordination event has occurred; and
resuming, by the computing device and based on determining that the thread coordination event has occurred, execution of the first thread.

2. The method of claim 1, further comprising:
executing, based on resuming execution of the first thread, the first thread coordination opcode in association with an instant of time; and
executing, based on determining that the thread coordination event has occurred, the second thread coordination opcode in association with the instant of time.

3. The method of claim 1, further comprising:
initiating or resetting, based on determining that the thread coordination event has occurred, a timer,
wherein a commencement time of the timer is an instant of time associated with:
the computing device executing, based on resuming execution of the first thread, the first thread coordination opcode, and
the computing device executing, based on determining that the thread coordination event has occurred, the second thread coordination opcode.

4. The method of claim 1, further comprising:
encountering, based on resuming execution of the first thread, a thread delay opcode that is included in the first thread;
re-suspending, based on encountering the thread delay opcode, execution of the first thread;
determining, after re-suspending execution of the first thread, that at least an amount of time indicated by the thread delay opcode has passed since executing the first thread coordination opcode in association with resuming execution of the first thread; and
re-resuming, based on determining that at least the amount of time indicated by the thread delay opcode has passed, execution of the first thread.

5. The method of claim 1, further comprising:
encountering, based on resuming execution of the first thread, a first thread delay opcode that is included in the first thread;
re-suspending, based on encountering the first thread delay opcode, execution of the first thread;
re-resuming execution of the first thread, based on determining that at least an amount of time indicated by the first thread delay opcode has passed since executing the first thread coordination opcode in association with resuming execution of the first thread;
encountering, based on re-resuming execution of the first thread, a second thread delay opcode that is included in the first thread; and
suspending again, based on encountering the second thread delay opcode, execution of the first thread.

6. The method of claim 5, further comprising:
resuming again, after suspending again execution of the first thread, and based on determining that at least an amount of time indicated by the second thread delay opcode has passed since executing the first thread coordination opcode in association with resuming execution of the first thread, execution of the first thread.

7. The method of claim 5, further comprising:
resuming again, after suspending again execution of the first thread, and based on determining that at least an amount of time indicated by the second thread delay opcode has passed since executing the first thread delay opcode in association with re-resuming execution of the first thread, execution of the first thread.

8. The method of claim 1, wherein the first thread coordination opcode includes a first identifier and the second thread coordination opcode includes a second identifier, and
wherein determining that the thread coordination event has occurred comprises:
determining that the thread coordination event has occurred based on the first identifier matching the second identifier.

9. The method of claim 1, wherein determining that the thread coordination event has occurred comprises:
determining that the first thread coordination opcode was encountered;
determining that the second thread coordination opcode was encountered;
determining that at least one other thread coordination opcode was encountered based on executing at least one other thread; and
determining that the thread coordination event has occurred based on determining that the first thread coordination opcode was encountered, determining that the second thread coordination opcode was encountered, and determining that at least one other thread coordination opcode was encountered based on executing at least one other thread.

10. A computing device, comprising:
one or more memories; and
a processor, coupled to the one or more memories, configured to:
execute a first thread;
encounter, based on executing the first thread, a first thread coordination operation code (opcode) that is included in the first thread; and
suspend, based on encountering the first thread coordination opcode, execution of the first thread.

11. The computing device of claim 10, wherein the processor is further configured to:
execute a second thread;
encounter, based on executing the second thread, and after suspending execution of the first thread, a second thread coordination opcode that is included in the second thread;
determine, based on encountering the first thread coordination opcode and encountering the second thread coordination opcode, that a thread coordination event has occurred; and
resume, based on determining that the thread coordination event has occurred, execution of the first thread.

12. The computing device of claim 10, wherein the processor is further configured to:
determine, after suspending execution of the first thread, that a thread coordination event has occurred;
resume, based on determining that the thread coordination event has occurred, execution of the first thread; and
initiate or reset, based on resuming execution of the first thread, a timer,
wherein a commencement time of the timer is an instant of time associated with the processor executing the first thread coordination opcode.

13. The computing device of claim 10, wherein the processor is further configured to:
encounter, based on resuming execution of the first thread after suspending execution of the first thread, a thread delay opcode that is included in the first thread; and
re-suspending, based on encountering the thread delay opcode, execution of the first thread for at least an amount of time indicated by the thread delay opcode.

14. The computing device of claim 13, wherein the amount of time indicated by the thread delay opcode is an amount of time since a commencement time of a timer that was initiated or reset based on resuming execution of the first thread.

15. The computing device of claim 13, wherein the amount of time indicated by the thread delay opcode is an amount of time since an instant of time associated with executing, based on resuming execution of the first thread after suspending execution of the first thread, another thread delay opcode that is included in the first thread.

16. A non-transitory computer-readable medium storing a set of instructions, the set of instructions comprising:
one or more instructions that, when executed by a processor of a computing device, cause the computing device to:
encounter, based on executing a first thread, a first thread coordination operation code (opcode) that is included in the first thread;
suspend, based on encountering the first thread coordination opcode, execution of the first thread;
encounter, based on executing a second thread, and after suspending execution of the first thread, a second thread coordination opcode that is included in the second thread; and
resume, based on encountering the first thread coordination opcode and encountering the second thread coordination opcode, execution of the first thread.

17. The non-transitory computer-readable medium of claim 16, wherein the one or more instructions further cause the computing device to:
execute, based on resuming execution of the first thread, and in association with an instant of time, the first thread coordination opcode and the second thread coordination opcode.

18. The non-transitory computer-readable medium of claim 16, wherein the one or more instructions further cause the computing device to:
initiate or reset, based on resuming execution of the first thread, a timer.

19. The non-transitory computer-readable medium of claim 16, wherein the one or more instructions further cause the computing device to:
encounter, based on resuming execution of the first thread, a thread delay opcode that is included in the first thread;
re-suspend, based on encountering the thread delay opcode, execution of the first thread; and
re-resume, based on an amount of time indicated by the thread delay opcode, execution of the first thread.

20. The non-transitory computer-readable medium of claim 16, wherein the amount of time indicated by the thread delay opcode is one of:
an amount of time since an instant in time associated with resuming execution of the first thread, or
an amount of time since executing another thread delay opcode that is included in the first thread.
